(19) United States
(12) Patent Application Publication
(10) Pub. No.: US 2007/0216664 A1
(43) Pub. Date: Sep. 20, 2007

(54) Stylus to assist data entry

(76) Inventor: Eric H. Marye, Dallas, TX (US)

Correspondence Address: Glast, Phillips & Murray, P.C, 13355 Noel Road, Suite 2200, Dallas, TX, 75240, US

(21) Appl. No.: 11/709,650

(22) Filed: Feb. 22, 2007

Related U.S. Application Data
(60) Provisional application No. 60/782,769, filed on Mar. 16, 2006.

(51) Int. Cl. G06F 3/033

(52) U.S. Cl. 345/179

(57) ABSTRACT

A stylus to assist data entry has a disk having a curvature outward to a thumb or finger. A nipple for pressing keys or the like is affixed to the disk. One or more attachments are affixed to the disk to engage a strap. The strap removably connects the stylus to the thumb or finger of a user. The stylus system also includes a docking station for receiving and holding the disk when it is not in use. Preferably, a slot in the docking station receives the nipple on the disk and holds it within the docking station.

### CLAIM FOR PRIORITY

This application claims the priority of U.S. provisional application Ser. No. 60/782,769, titled “Stylus to assist data entry,” filed Mar. 16, 2006.

### TECHNICAL FIELD

This disclosure is directed to the field of devices that assist data entry by the human hand.

### BACKGROUND

Personal computing devices (PDA's) or cellular telephones have limited areas for data entry by a user's finger or thumb. In many cases, it is simpler or even necessary to use a pen or stylus of some sort to assist the entry. This in turn can be awkward if the user must locate the stylus and hold it in one hand while holding the PDA or telephone in the other. What is needed is a stylus device easily mounted to a user's thumb or finger, but which can be conveniently removed and stored.

### DRAWINGS

FIG. 1 shows perspective and plan views of the of the stylus of the preferred embodiment, including a strap for securing it to the thumb or finger of a user.

FIG. 2 is a perspective view of the disk and nipple portion of the preferred embodiment.

FIG. 3 is plan and perspective views of the docking station for the disk of the stylus.

FIG. 4 shows perspective views of an alternate embodiment.

### DESCRIPTION

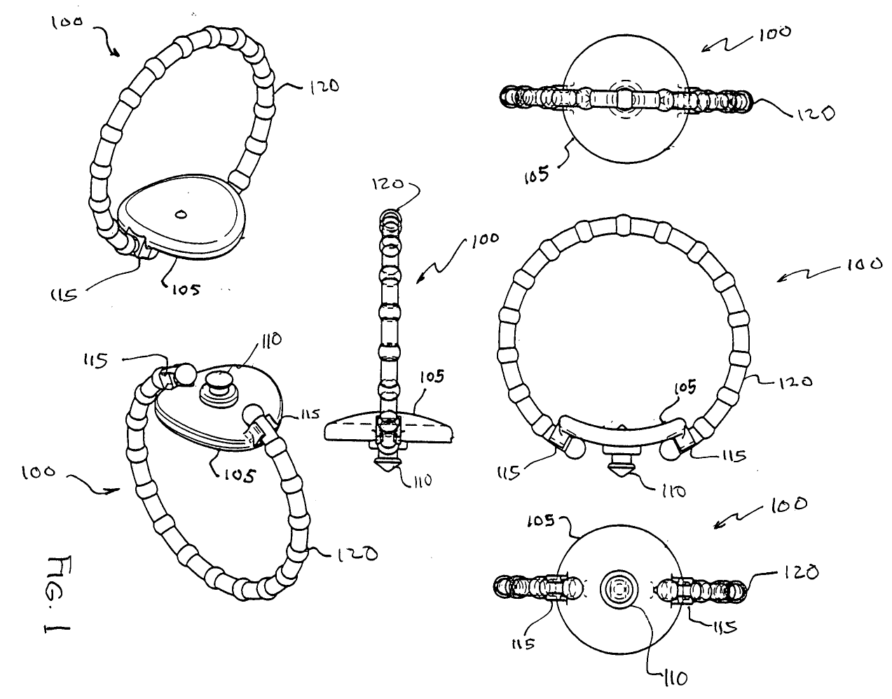

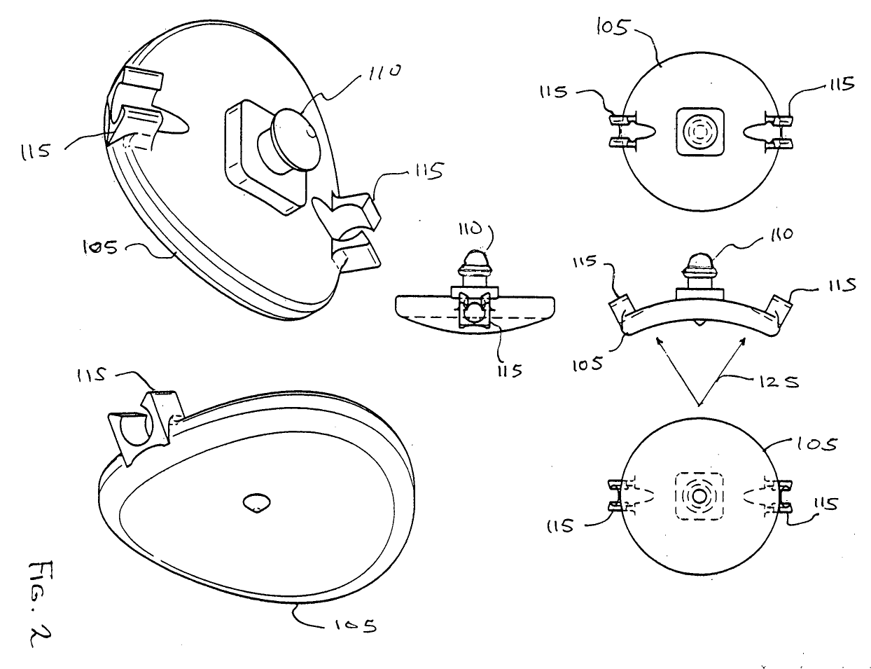

FIG. 1 shows the stylus of the preferred embodiment. The stylus (100) includes an approximately circular disk (105) having a nipple (110) centered on one side of the disk (105). The nipple (100) may be of any durable substance such as hard plastic or metal. The shape of the disk (105) preferably has a curvature (125) as shown in FIG. 2 to conform to the shape of a human thumb or finger. The disk (105) need not be a true “disk,” but may have a non-circular shape.

The stylus (100) has attachments (115) for engaging a means (120) to removably attach the stylus (100) to a thumb or finger. Such attachment means (120) could be stringed beads engaged by the attachments (115), or straps or belts of various kinds sufficient to hold the stylus disk (105) to the finger while the user is pressing keys or touch-sensitive surfaces on a data-entry device with the nipple (110).

FIG. 2 shows in more detail the disk and nipple for data entry of the preferred embodiment.

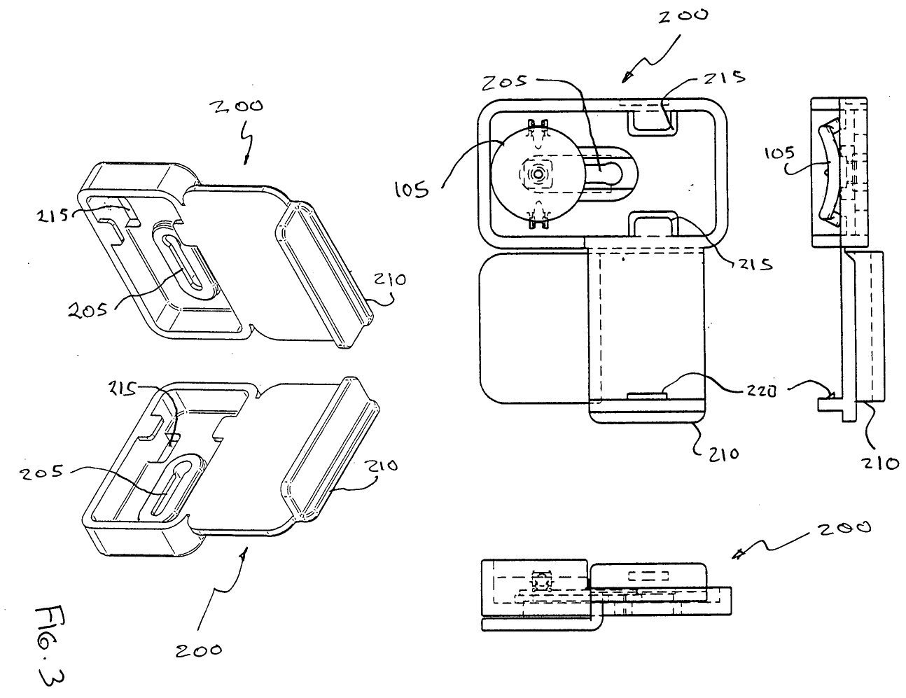

FIG. 3 shows a docking station or holding case (200) for the stylus (100) of the preferred embodiment. The docking station (200) has a slot (205) for receiving and holding the stylus (100) when it is not in use. In the preferred embodiment, the nipple (110) of the stylus (100) engages the slot (205). The docking station has a lid (210) to close over the stylus (100). Preferably, the lid (210) has openings (215) for a lanyard (not shown) and a latch (220) for the lid (210). The docking station (200) is conveniently made of a suitable plastic.

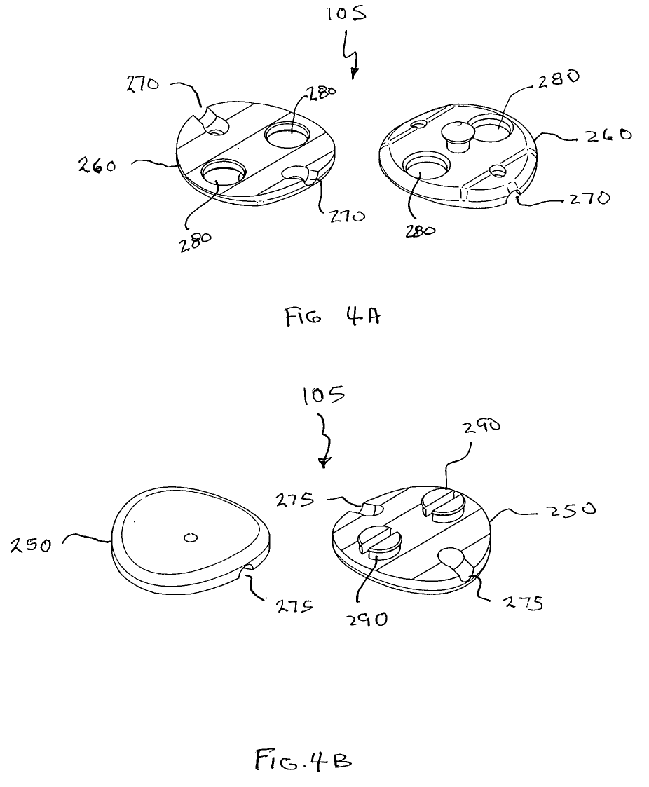

FIG. 4 show perspective views of an alternate embodiment, where the disk (105) comprises two parts that join together removably to engage the strap 120. FIG. 4A shows the reverse and obverse sides of the nipple part (260) of the composite disk (105). FIG. 4B shows the reverse and obverse sides of the thumb part (250) of the composite disk (105). The alternate embodiment has first and second attachment grooves (270, 275) for engaging the ends of the strap (120). Holes (280) in the nipple part (260) of the composite disk (105) engage plugs (290) in the thumb part (250). Alternatively, the holes (280) and plugs (290) could be positioned in the thumb part (250) and nipple part (260) respectively. The plugs (290) snap into the holes (280) over the ends of the strap (120), thus holding it firmly.

I claim:

1. A stylus to assist data entry, the stylus comprising:
a disk;
a nipple affixed to the disk;
one or more attachments affixed to the disk for engaging a means for removably connecting the stylus to a finger or thumb.

2. The stylus of claim 1, where the means for removably connecting the stylus to a finger or thumb is a strap.

3. The stylus of claim 2 where the strap comprises string beads engaged by the attachments.

4. The stylus of claim 1 where the disk has a curvature outward relative to the thumb or finger to which it is connected.

5. The stylus of claim 1, further comprising a docking station for receiving and holding the disk when not in use.

6. The stylus of claim 5 where the docking station further comprises a slot for receiving the nipple of the disk.

7. The stylus of claim 5 where the docking station further comprises an opening for receiving a lanyard.

8. The stylus of claim 5 where the docking station further comprises a lid for covering the disk when not in use.

9. The stylus of claim 1 where the disk further comprises:
a nipple part;
the nipple part having holes therein;
the nipple part having first grooves therein for engaging a strap;
a thumb part;
the thumb part having plugs for engaging the holes in the nipple part;
the thumb part having second grooves therein corresponding to the position of the first grooves.

10. The stylus of claim 1 where the disk further comprises:
a nipple part;
the nipple part having plugs;
the nipple part having first grooves therein for engaging a strap;
a thumb part;
the thumb part having holes therein for engaging the plugs in the nipple part;
the thumb part having second grooves therein corresponding to the position of the first grooves.

11. A stylus to assist data entry, the stylus comprising:
a disk;
the disk having a curvature outward to a thumb or finger;
a nipple affixed to the disk;
one or more attachments affixed to the disk;
a strap engaged by the one or more attachments, for removably connecting the stylus to the thumb or finger;
a docking station for receiving and holding the disk; the docking station further comprising:
a slot for receiving the nipple of the disk;
an opening for receiving a lanyard; and,
a lid, for covering the disk when not in use.

12. A stylus to assist data entry, the stylus comprising:
a disk;
the disk having a curvature outward relative to a thumb or finger;
the disk further comprising:
a nipple part;
the nipple part having a nipple affixed thereto;
the nipple part having holes therein;
the nipple part having first grooves therein for engaging a strap; and,
a thumb part;
the thumb part having plugs for engaging the holes in the nipple part;
the thumb part having second grooves therein corresponding to the position of the first grooves.
the strap engaged by the first and second grooves, for removably connecting the stylus to the thumb or finger; and,
a docking station for receiving and holding the disk; the docking station further comprising:
a slot for receiving the nipple of the disk;
an opening for receiving a lanyard; and,
a lid, for covering the disk when not in use.
